(19) United States
(12) Patent Application Publication
(10) Pub. No.: US 2006/0266140 A1
(43) Pub. Date: Nov. 30, 2006

(54) Integrated lock ring and rack bushing for rack and pinion steering assembly

(76) Inventor: Dennis F. Harer, Kingsport, TN (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/141,227

(22) Filed: May 31, 2005

(51) Int. Cl. F16H 29/02

(52) U.S. Cl. 74/89.12; 74/422

(57) ABSTRACT

The invention contemplates a rack bushing employed within a rack assembly for use with a housing in a rack and pinion steering assembly, where the housing includes a tubular end within which the rack bushing assembly is mountable. The rack bushing assembly incorporates a rack bushing having a main body, made of metal, including a cylindrical inner surface and a cylindrical outer surface and having a first end and a second end. The main body also includes an integral lock ring portion adjacent to the first end having a retaining wire slot extending around the outer surface and a retaining wire bore extending radially inward from the outer surface. A retaining wire is mounted in the retaining wire slot and bore and cooperates with the integral lock ring portion to provide for retention of the rack bushing assembly within the tubular end of the housing.

### BACKGROUND OF INVENTION

The present invention relates generally to automotive vehicle steering systems and, in particular, to an integrated lock ring and rack bushing for a rack and pinion steering assembly.

A typical hydraulic rack and pinion power steering assembly used in a vehicle includes a rack that extends axially through a hydraulic chamber inside a hydraulic housing. The ends of the rack project axially outward from each end of the housing and are connected with steering linkages that connect to steerable vehicle wheels. A piston is fixed to the rack within the hydraulic chamber. Rotation of the vehicle steering wheel actuates a hydraulic valve and causes hydraulic fluid under pressure to act against the piston. The force exerted by the hydraulic fluid moves the piston within the housing, causing the rack to move axially. The axial movement of the rack moves the steering linkages that, in turn, cause the corresponding vehicle wheels to turn.

To prevent hydraulic fluid from flowing out of the housing, it is necessary to seal the-ends of the housing through which the rack projects. It is also desirable to support the rack for axial movement within the housing without losing the integrity of the seal. A bushing and seal assembly is typically used for this purpose. It is also known to enclose the ends of the housing with bellows attached to the outside of the housing to prevent moisture, dirt or other contaminants from entering and interfering with the operation of the rack.

Machined aluminum rack bushings that employ inner liners for bearing against the rack and outer rubber O-rings compressed against the housing are known. The aluminum rack bushing is pressed into a specified location against the tube housing inside diameter and then locked in place with insertion of a steel or zinc lock ring and lock wire into the tube housing. The tube housing may include an extruded inside diameter, flared tube end, pierced wire slot, and wire groove cut in the tube inside diameter in order to allow for the assembly and retention of the rack bushing assembly. The aluminum rack bushings are advantageous in that they are readily capable of withstanding the side loads induced on the bushing during vehicle operation. But such bushing assemblies can be more expensive than is desirable and require the fabrication and assembly of more separate parts than is desirable.

Molded plastic rack bushings with steel or zinc lock rings have been employed, but again, there are more separate parts to fabricate and assemble than is desired. Molded plastic rack bushings that integrate a lock ring have also been attempted, but such bushings are less capable of accepting the high side loads and axial impact loads that may be induced in the bushing during vehicle operation—thus creating concerns with cracking of the bushing.

It is desirable, therefore, to have a rack bushing employed with a rack and pinion steering assembly that overcomes the drawbacks of the prior art.

### SUMMARY OF INVENTION

According to an aspect of the invention, there is provided a rack bushing for use with a rack portion of a housing in a rack and pinion steering assembly, where the rack portion includes a tubular end within which the rack bushing is mountable. The rack bushing has a generally annular main body, made of metal, including a generally cylindrical inner surface and a generally cylindrical outer surface and having a first end and an opposed second end. The main body also includes an integral lock ring portion adjacent to the first end and adapted to provide for retention of the rack bushing within the tubular end of the rack portion. The main body is preferably a casting made of zinc.

According to another aspect of the invention, there is provided a rack bushing assembly for use with a rack portion of a housing in a rack and pinion steering assembly, where the rack portion includes a tubular end within which the rack bushing assembly is mountable. The rack bushing assembly incorporates a rack bushing having a generally annular main body, made of metal, including a generally cylindrical inner surface and a generally cylindrical outer surface and having a first end and an opposed second end. The main body also includes an integral lock ring portion adjacent to the first end having a retaining wire slot extending circumferentially around the outer surface and a retaining wire bore extending radially inward from the outer surface. A retaining wire is mounted in the retaining wire slot and retaining wire bore and is adapted to cooperate with the integral lock ring portion to provide for retention of the rack bushing assembly within the tubular end of the rack portion.

According to another aspect of the invention, there is provided a rack and pinion steering assembly for use in a vehicle. The rack and pinion steering assembly includes a housing having a tubular rack portion with a tubular end, and a rack mounted in the tubular rack portion and extending out of the tubular end. The rack and pinion steering assembly also includes a rack bushing assembly including a rack bushing mounted within the tubular end and having a generally annular main body, made of metal, including a generally cylindrical inner surface through which the rack extends and a generally cylindrical outer surface and having a first end and an opposed second end. The main body includes an integral lock ring portion adjacent to the first end having a retaining wire slot extending circumferentially around the outer surface and a retaining wire bore extending radially inward from the outer surface. A retaining wire is mounted in the retaining wire slot and retaining wire bore and cooperates with the integral lock ring portion to provide for retention of the rack bushing assembly within the tubular end of the rack portion.

The present invention advantageously provides a rack bushing assembly that is strong enough to withstanding the side loads induced on the bushing during vehicle operation, yet reduces the number of parts that must be fabricated and assembled into the rack bushing assembly.

Another advantage of an embodiment of the present invention is that it can be employed with prior rack and pinion housings that were designed to accept previous machined aluminum bushing assemblies that employed separate lock rings. Thus, the cost to employ the present invention in an existing steering assembly design can be minimized.

### BRIEF DESCRIPTION OF DRAWINGS

FIG. 1 is a schematic view of a rack and opinion steering assembly according to the present invention.

FIG. 2 is a schematic view of a portion of a first end of the rack and pinion steering assembly of FIG. 1, but without the bellows or steering linkage shown.

FIG. 3 is a partially exploded perspective view of the rack bushing assembly according to the present invention.

FIG. 4 is a perspective view of the rack bushing assembly of FIG. 3, looking at the rack bushing assembly from the opposite direction and without the retaining wire shown.

FIG. 5 is a sectional view taken a long line 5-5 in FIG. 4.

FIG. 6 is an end view of the rack bushing according to the present invention.

FIG. 7 is a sectional view taken along line 7-7 in FIG. 6.

FIG. 8 is a perspective view of a liner in accordance with the present invention.

### DETAILED DESCRIPTION

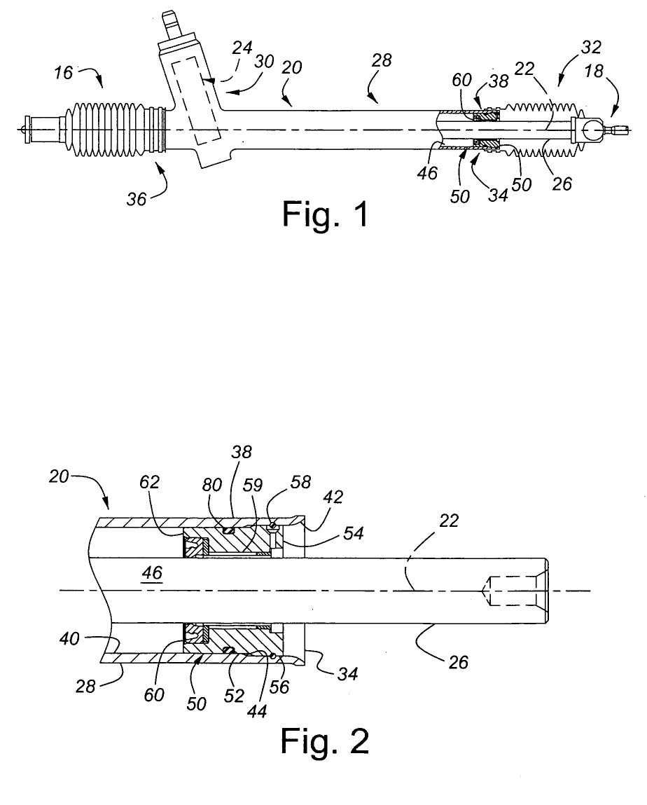

FIGS. 1-2 illustrate a portion of a steering assembly, indicated generally at 16, for use in a vehicle (not shown). The steering assembly 16 is connected with a pair of steerable vehicle wheels (not shown) in a known manner by a steering linkage 18 at one end of the steering assembly 16 and by a similar steering linkage (not shown) at the other end of the steering assembly 16. The steering assembly 16 includes a housing 20 defining a longitudinally oriented rack axis 22, a pinion 24, and a rack 26 that has the same rack axis as the housing 20. The housing 20 includes a longitudinally extending rack portion 28 and a transversely extending pinion portion 30. The rack 26 extends through the rack portion 28. The pinion 24 is located in the pinion portion 30 of the housing 20 and engages with the rack 26 in a known manner. A bellows 32 encircles and encloses the portion of the rack 26 extending from the housing 20. The bellows 32 mounts around and is secured to the housing 20 in a known manner, and is flexible to allow for telescopic movement of the pinion 24 relative to the housing 20 while keeping dirt and other contaminants out of the steering assembly 16.

The rack portion 28 of the housing 20 has a first tubular end 34 and an opposed second tubular end 36. The rack portion 28 at the first tubular end 34 includes a cylindrical outer surface 38 and a generally cylindrical inner surface 40. The inner surface 40 may include a flared portion 42, used for ease of assembly, a stop feature 44, and a central portion that defines a fluid chamber 46. As is known to those skilled in the art, a piston (not shown) is fixed to the rack 26 inside the fluid chamber 46. Upon rotation of the vehicle steering wheel (not shown), fluid under pressure in the fluid chamber 46 acts against the piston, causing the rack 26 to move axially within the housing 20. Such axial movement of the rack 26 causes a corresponding movement in the steering linkages 18, thus turning the steerable vehicle wheels in the desired, direction.

The steering assembly 16 also includes a rack bushing assembly 50 that mounts in the first tubular end 34 around the rack 26, and is centered about the rack axis 22. A similar bushing assembly (not shown) may be located at the second tubular end 36 of the housing 20.

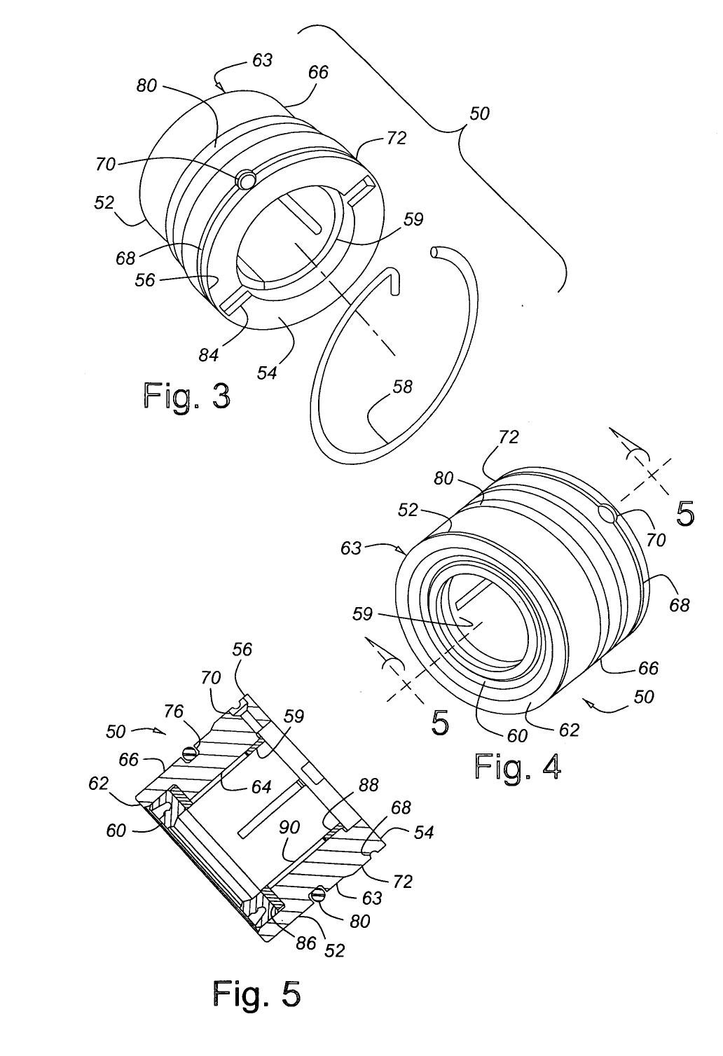

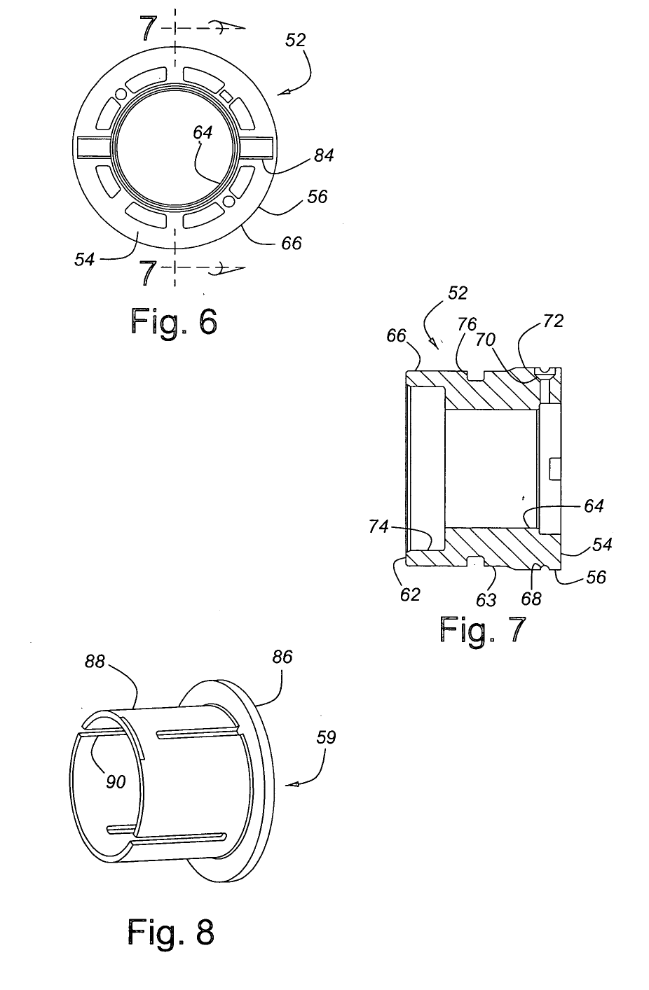

FIGS. 3-8 illustrate the rack bushing assembly 50 of FIGS. 1 and 2, and its components, in more detail. The rack bushing assembly 50 includes a rack bushing 52 having a generally annular main body 63 that includes a cylindrical inner surface 64 and a generally cylindrical outer surface 66. The rack bushing 52 has a first end 54 that includes an integral lock ring portion 56. The term integral, as used herein, means that the lock ring portion 56 is formed with the main body 63 as a single, monolithic piece—not two separate pieces that are later mated or secured together.

The main body 63 of the rack bushing 52 may also include an enlarged diameter portion 72 extending radially outward from the outer surface 66, adjacent to the first end 54 of the bushing 52, which would include the integral lock ring portion 56. This enlarged diameter portion 72 provides for positive axial locating of the rack bushing 52 relative to the housing 20 by allowing the insertion of the rack bushing 52 into the housing 20 until the enlarged diameter portion 72 abuts the stop feature 44 in the housing 20.

The first end 54 of the main body 63 includes slots 84 recessed therein. The slots 84 are used in a conventional manner to assemble a retaining wire 58, discussed below, to the bushing 52.

The integral lock ring portion 56 of the main body 63 includes a circumferentially oriented, annular retaining wire retention slot 68 and a radially oriented, retaining wire bore 70. The retention slot 68 and bore 70 receive a retaining wire 58, which engages the inner surface 40 of the rack portion 28, securing the rack bushing assembly 50 in the housing 20.

The rack bushing assembly 50 also includes a liner 59. The liner 59 includes a radially extending flange portion 86, which is nested in a seal recess 74 in a second end 62 of the rack bushing 52 and holds the liner 59 in the proper axial location, and an axially extending cylindrical portion 88, which mounts against the cylindrical inner surface 64 of the rack bushing 52. The cylindrical portion 88 of the liner 59 provides the bearing surface against which the rack 26 slides. The cylindrical portion 88 may include slots 90, which allow for ease of installation of the liner 59 into the bushing 52.

The main body 63 of the rack bushing 52 may also include a circumferentially oriented, annular seal recess 76. An O-ring seal 80 mounts in this recess 76. The O-ring seal 80 may be made of an elastomeric material.

The bushing assembly 50 may have an annular seal 60, which is mounted in the seal recess 74 against the flange portion 86 and seals around the rack 26 in a conventional manner. The second end 62 of the rack bushing 52 and seal 60 define one end of the fluid chamber 46. A second end of the fluid chamber 46 is defined by a bushing assembly (not shown) at the second end 36 of the rack portion 28 of the housing 20. As an alternative, the annular seal recess 76 and the seal recess 74 may be reduced or eliminated if a step seal (not shown) is employed.

The rack bushing 52 is preferably a die cast part, made of zinc, and is preferably cast to final dimensions without any machining operations after forming. The zinc may be, for example, a ZAMAK 5 zinc (a zinc alloy with about four percent aluminum, one percent copper, and 0.05 percent magnesium). Alternatively, the rack bushing 52 may be made of another suitable metal, such as aluminum, steel, or powdered metal, but would most likely require secondary machining of specific features. Again, the preference is to cast to final dimensions—minimizing the cost to fabricate and assemble the bushing 52. The liner 59 is preferably a molded part, and may be made, for example, from a nylon polymer, such as, for example, Zytel®, made by DuPont—although, other suitable plastic materials can be used instead, if so desired.

While certain embodiments of the present invention have been described in detail, those familiar with the art to which this invention relates will recognize various alternative designs and embodiments for practicing the invention as defined by the following claims.

1. A rack bushing for use with a rack portion of a housing in a rack and pinion steering assembly, where the rack portion includes a tubular end within which the rack bushing is mountable, the rack bushing comprising a main body, made of metal, including an inner surface and an outer surface and having a first end and an opposed second end, and wherein the main body includes an integral lock ring portion adjacent to the first end and adapted to provide for retention of the rack bushing within the tubular end of the rack portion, and wherein the main body includes an enlarged diameter portion extending radially outward from the outer surface adjacent to the first end and adapted to abut a stop feature extending radially inward from the rack portion and spaced from the tubular end.

2. The rack bushing of claim 1 wherein the main body is made of zinc.

3. The rack bushing of claim 1 wherein the main body is a casting formed from ZAMAK 5 zinc.

4. The rack bushing of claim 3 wherein the integral lock ring portion of the main body further includes a retaining wire slot extending circumferentially around the outer surface and a retaining wire bore extending radially inward from the outer surface, wherein the retaining wire slot and retaining wire bore are adapted for receiving a retaining wire therein.

5. The rack bushing of claim 1 wherein the integral lock ring portion of the main body further includes a retaining wire slot extending circumferentially around the outer surface and a retaining wire bore extending radially inward from the outer surface, wherein the retaining wire slot and retaining wire bore are adapted for receiving a retaining wire therein.

6. (canceled)

7. (canceled)

8. The rack bushing of claim 1 wherein the second end includes a seal recess adjacent to the inner surface and adapted to receive an annular rack seal therein.

9. The rack bushing of claim 1 further including a circumferentially oriented annular recess extending around the outer surface and adapted to receive an O-ring seal therein.

10. A rack bushing assembly for use with a rack portion of a housing in a rack and pinion steering assembly, where the rack portion includes a tubular end within which the rack bushing assembly is mountable, the rack bushing assembly comprising:
a rack bushing having a main body, made of metal, including a an inner surface and an outer surface and having a first end and an opposed second end, and wherein the main body includes an integral lock ring portion adjacent to the first end having a retaining wire slot extending circumferentially around the outer surface and a retaining wire bore extending radially inward from the outer surface, and wherein the main body includes an enlarged diameter portion extending radially outward from the outer surface adjacent to the first end and adapted to abut a step feature extending radially inward from the rack portion and spaced from the tubular end; and
a retaining wire mounted in the retaining wire slot and retaining wire bore and adapted to cooperate with the integral lock ring portion to provide for retention of the rack bushing assembly within the tubular end of the rack portion.

11. The rack bushing assembly of claim 10 further including a liner having an axially extending portion mounted in the inner surface of the bushing and adapted to operatively engage a rack.

12. The rack bushing assembly of claim 10 wherein the second end includes a seal recess adjacent to the inner surface, and further including an annular rack seal mounted in the seal recess and adapted to operatively engage a rack.

13. The rack bushing assembly of claim 10 wherein the main body is made of zinc.

14. The rack bushing assembly of claim 10 wherein the main body is a casting formed from ZAMAK 5 zinc.

15. (canceled)

16. (canceled)

17. A rack and pinion steering assembly for use in a vehicle comprising:
a housing having a tubular rack portion with a tubular end, and an inner surface having a stop feature extending radially inward from the inner surface, and with the stop feature spaced from the tubular end;
a rack mounted in the tubular rack portion and extending out of the tubular end; and
a rack bushing assembly including a rack bushing mounted within the tubular end and having a main body, made of metal, including an inner surface through which the rack extends and an outer surface and having a first end and an opposed second end, and wherein the main body includes an integral lock ring portion adjacent to the first end having a retaining wire slot extending circumferentially around the outer surface and a retaining wire bore extending radially inward from the outer surface; and a retaining wire mounted in the retaining wire slot and retaining wire bore and cooperating with the integral lock ring portion to provide for retention of the rack bushing assembly within the tubular end of the rack portion, and wherein the main body includes an enlarged diameter portion extending radially outward from the outer surface adjacent to the first end and abutting the stop feature.

18. (canceled)

19. The rack and pinion steering assembly of claim 17 wherein the main body is a casting formed from zinc.

20. The rack and pinion steering assembly of claim 17 further including means for sealing around the rack adjacent to the rack bushing.
